(19) United States
(12) Patent Application Publication
(10) Pub. No.: US 2023/0180076 A1
(43) Pub. Date: Jun. 8, 2023

(54) MOBILITY HANDLING BETWEEN UU PATH AND PC5 RELAY PATH

(71) Applicant: QUALCOMM Incorporated, San Diego, CA (US)

(72) Inventors: Karthika PALADUGU, San Diego, CA (US); Hong CHENG, Basking Ridge, NJ (US); Gavin Bernard HORN, La Jolla, CA (US); Peng CHENG, Beijing (CN)

(21) Appl. No.: 17/906,159

(22) PCT Filed: Apr. 20, 2020
(86) PCT No.: PCT/CN2020/085580

§ 371 Date: Sep. 12, 2022

(51) Int. Cl. H04W 36/00; H04W 76/30

(52) U.S. Cl. CPC H04W 36/00837; H04W 36/0058; H04W 76/30

(57) ABSTRACT

Certain aspects of the present disclosure provide techniques for switching between a first path and a second path when certain selection criteria are met. The first path may be a Uu connection whereby the remote UE is connected directly to a network entity. The second path may be a connection whereby the remote UE is connected to the network entity (i.e., indirectly) via a relay UE (e.g., by a PC5 connection).

### FIELD OF THE DISCLOSURE

Aspects of the present disclosure relate to wireless communications, and more particularly, to techniques for handling device-to-device connections and network connections.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a remote user equipment (UE). The method generally includes receiving signaling for a configuration of selection criteria for mobility procedures for a switch between a first path whereby the remote UE is connected directly to a network entity and a second path whereby the remote UE is connected to the network entity via a relay UE, and taking action(s) to initiate the switch if the selection criteria are met.

Certain aspects provide a method for wireless communication by a relay UE. The method generally includes receiving, via a second path, a measurement report from a remote UE indicating measurements of at least one of downlink signals from a network entity on a first path or downlink signals from the relay UE on the second path, and taking action(s) to assist the remote UE in switching from the second path to the first path.

Certain aspects provide a method for wireless communication by a wireless entity. The method generally includes receiving signaling from a remote UE indicating selection criteria for mobility procedures, for a switch between a first path whereby the remote UE is connected directly to the network entity and a second path whereby the remote UE is connected to the network entity via a relay UE, are met, and taking action(s) to assist the remote UE with the switch.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a high level path diagram illustrating example connection paths of a remote user equipment (UE), in accordance with certain aspects of the present disclosure.

FIG. 6 is an example block diagram illustrating a control plane protocol stack on L3, when there is no direct connection path between the remote UE and the network node, in accordance with certain aspects of the present disclosure.

FIG. 7 is an example block diagram illustrating a control plane protocol stack on L2, when there is direct connection path between the remote UE and the network node, in accordance with certain aspects of the present disclosure.

FIG. 8 is an example block diagram illustrating a user plane protocol stack on L3, when there is no direct connection path between the remote UE and the network node, in accordance with certain aspects of the present disclosure.

FIG. 9 is an example block diagram illustrating a user plane protocol stack on L2, when there is direct connection path between the remote user equipment and the network node, in accordance with certain aspects of the present disclosure.

FIG. 10 is an example block diagram illustrating an architecture scheme of L3 relay enhancement.

FIG. 11 is a flow diagram illustrating example operations that may be performed by a remote UE, in accordance with certain aspects of the present disclosure.

FIG. 12 is a flow diagram illustrating example operations that may be performed by a relay UE, in accordance with certain aspects of the present disclosure.

FIG. 13 is a flow diagram illustrating example operations that may be performed by a network entity, in accordance with certain aspects of the present disclosure.

FIG. 14 is an example call flow diagram showing overall trigger related communication, in accordance with certain aspects of the present disclosure;

FIG. 15 is an example call flow diagram showing overall trigger related communication, in accordance with certain aspects of the present disclosure;

FIG. 16 is an example call flow diagram showing a Uu-PC5 mobility switch enabled by a relay UE, in accordance with certain aspects of the present disclosure;

FIG. 17 is an example call flow diagram a Uu-PC5 mobility switch enabled by a network, in accordance with certain aspects of the present disclosure;

FIG. 18 is an example call flow diagram showing a Uu-PC5 mobility switch enabled by a network while maintaining Uu path connection, in accordance with certain aspects of the present disclosure;

FIG. 19 is an example call flow diagram showing a Uu-PC5 mobility switch returning to a Uu path connection, in accordance with certain aspects of the present disclosure;

FIG. 20 is an example call flow diagram showing a Uu-PC5 mobility switch handing over to a PC5 path connection, in accordance with certain aspects of the present disclosure;

FIG. 21 is an example call flow diagram showing a Uu-PC5 mobility switch in an intra-network setting, in accordance with certain aspects of the present disclosure;

FIG. 22 is an example call flow diagram showing a Uu-PC5 mobility switch in an inter-network setting, in accordance with certain aspects of the present disclosure;

FIG. 23 is another example call flow diagram showing a Uu-PC5 mobility switch in an inter-network setting, in accordance with certain aspects of the present disclosure;

FIG. 24 illustrates a communications device that may include various components configured to perform the operations illustrated in FIG. 11, in accordance with certain aspects of the present disclosure.

FIG. 25 illustrates a communications device that may include various components configured to perform the operations illustrated in FIG. 12, in accordance with certain aspects of the present disclosure.

FIG. 26 illustrates a communications device that may include various components configured to perform the operations illustrated in FIG. 13, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for providing switching mobility between a connection to an infrastructure node and a connection between two user equipments (UEs). The first connection, between a UE (hereinafter “remote UE”) and an infrastructure node (e.g., gNB) of a network entity, may be called a Uu connection or via a Uu path. The remote UE in Uu connection may use a regular cellular mode, for example, via a base station, to access network resources. For example, the remote UE may communicate with the network entity using the Uu connection through a serving base station by means of regular cellular links.

The second connection, between the remote UE and another UE (hereinafter the “relay UE”), may be called a PC5 connection or via a PC5 path. The PC5 connection is a device-to-device connection that may take advantage of the comparative proximity between the remote UE and the relay UE (e.g., when the remote UE is closer to the relay UE than to the closest base station). The relay UE may further connect to an infrastructure node (e.g., gNB) via a Uu connection and relay the Uu connection to the remote UE through the PC5 connection. The present disclosure provides various examples to illustrate when and how to switch the remote UE from one connection (the Uu connection or the PC5 connection) to the other for enabling the remote UE to have the most effective and/or efficient connection with the network or the relay UE.

Absent the PC5 connection, the remote UE may connect to the relay UE through the common network that both the remote UE and the relay UE are in communication with. But when the remote UE can efficiently communicate with the relay UE via a sidelink (e.g., V2X), the remote UE may gain capacity, increase throughput, have less latency, and/or increase reliability using the sidelink without the network. In other situations, the remote UE may prefer connect to the network via the relay UE when such indirect connection improves the communication performance. In this disclosure, the change between the Uu connection (i.e., direct connection with a network) and the PC5 connection (i.e., direct connection with another UE, or the relay UE) may be called relay mobility, switch, or handover. Aspects of the present disclosure pertains to (1) when such relay mobility should be triggered, (2) upon trigger, how each of the remote UE, the relay UE, and the network should behave during the switch procedure; and (3) upon completion, how each of the remote UE, the relay UE, and the network should act.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. Cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). Cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

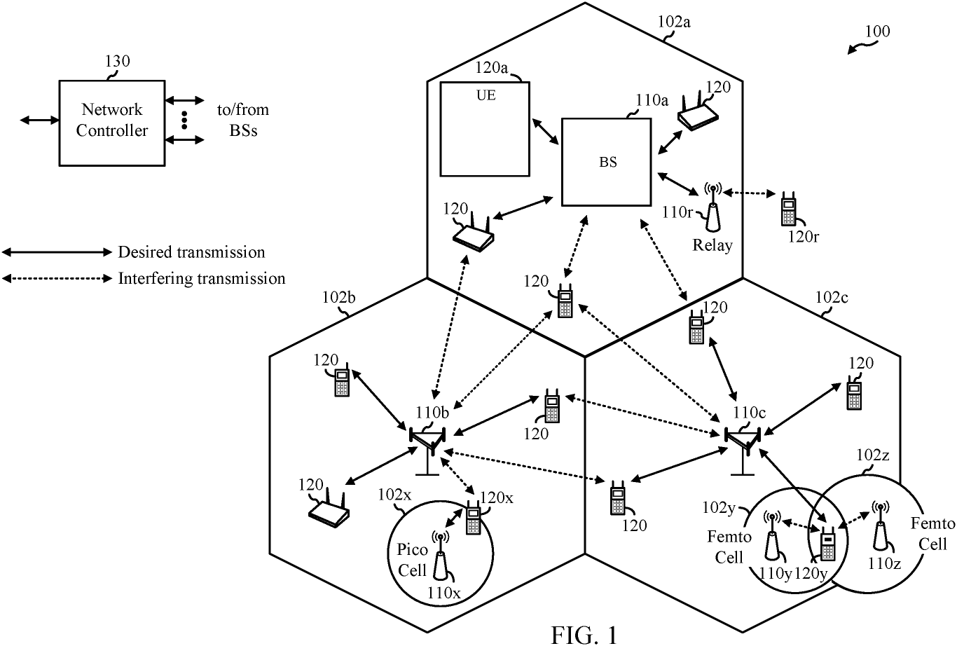

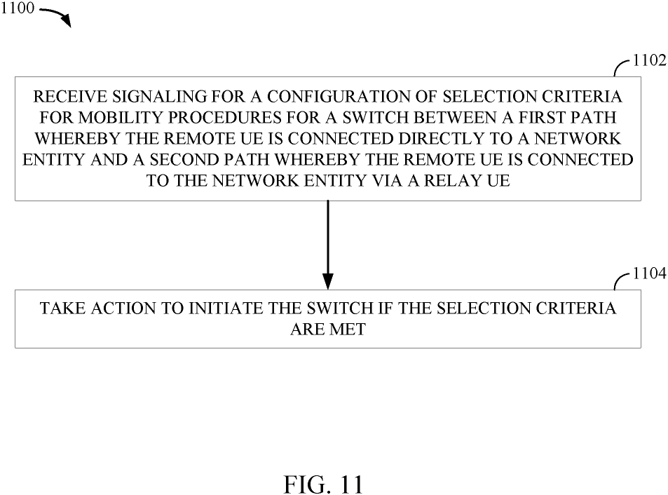

FIG. 1 illustrates an example wireless communication network 100 in which aspects of the present disclosure may be performed. For example, UEs 120a and/or BS 110a of FIG. 1 may be configured to perform operations 1100, 1200, and 1300 described below with reference to FIGS. 11, 12, and 13 to perform mobility of remote UE between a direct connection with a network and a connection via a relay UE.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

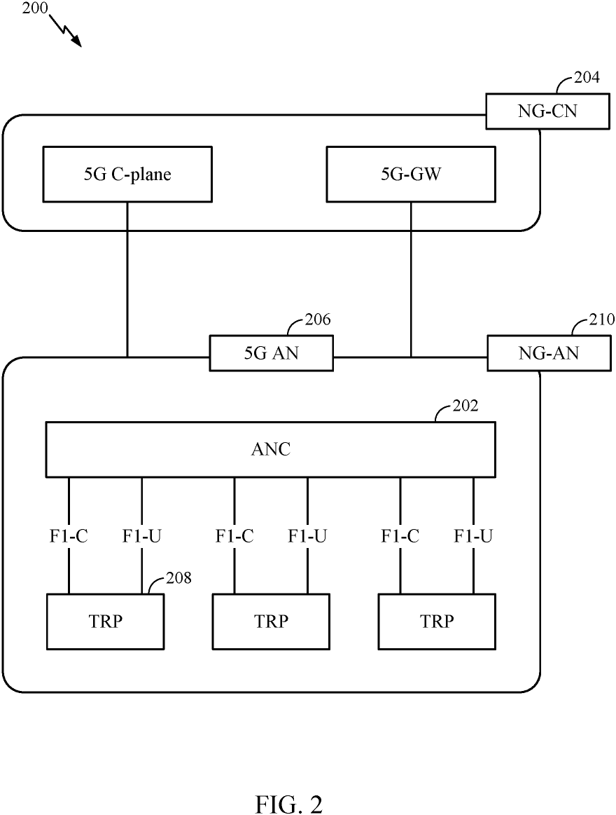

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

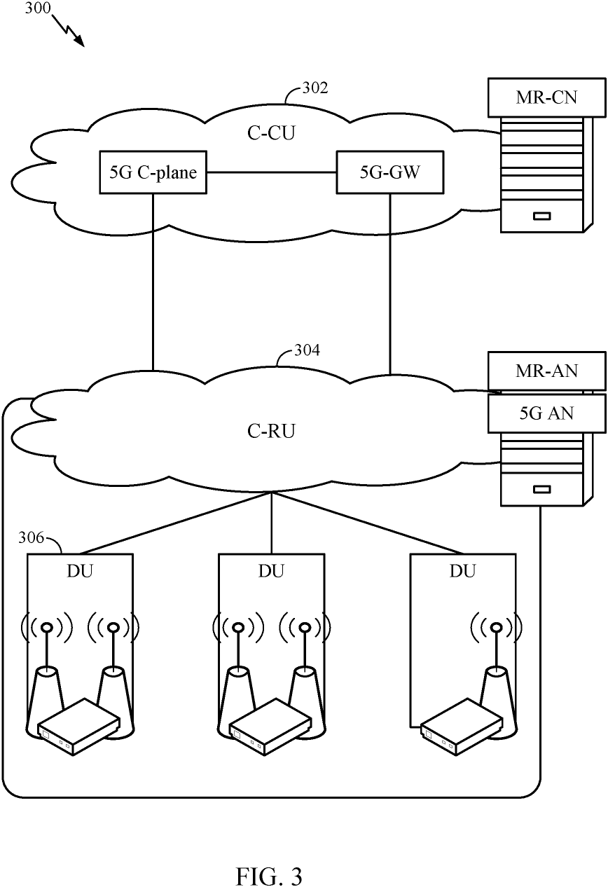

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

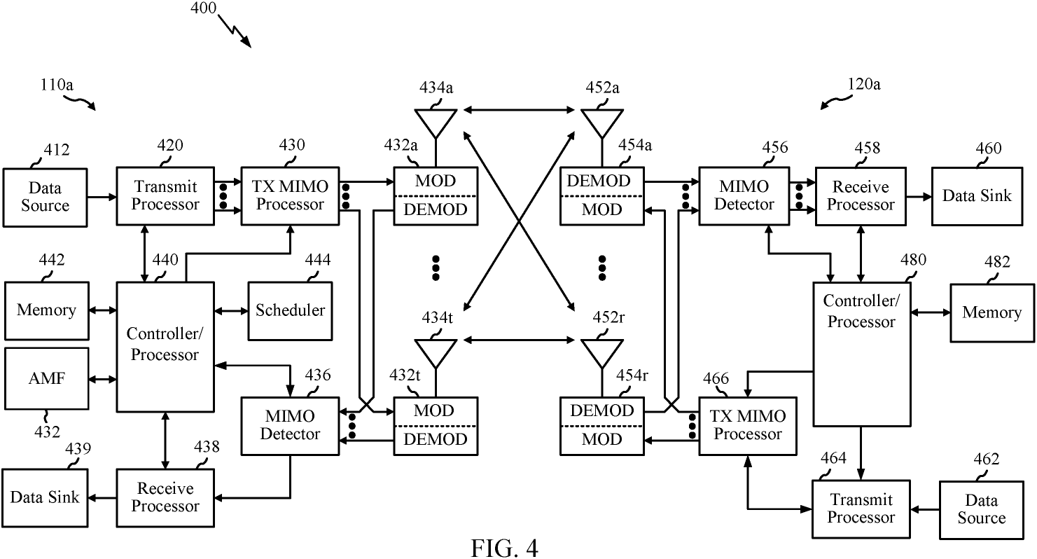

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a and/or antennas 434, processors 420, 430, 438, and/or controller/processor 440 of the BS 110a may be used to perform the various techniques and methods described herein with reference to FIGS. 11, 12, and 13.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein with reference to FIGS. 11, 12, and 13.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

### Example UE to NW Relay Mobility

Aspects of the present disclosure provide apparatus, methods, processing systems, and computer readable mediums for switching between a first path and a second path when certain selection criteria are met. The first path may be a Uu connection whereby the remote UE is connected directly to a network entity. The second path may be a connection whereby the remote UE is connected to the network entity (i.e., indirectly) via a relay UE (e.g., by a PC5 connection).

For example, an example embodiment includes a method for a remote UE to respectively switch to or from a device-to-device sidelink communication (e.g., over a PC5 path) from or to a regular cellular communication (e.g., over a Uu path). The switching may include releasing the sidelink PC5 connections for Uu connections; or alternatively, establishing or switching to primarily using sidelink PC5 connections and releasing Uu connections, when selection criteria, such as intra-frequency, inter-frequency, or other status/measurements, are met.

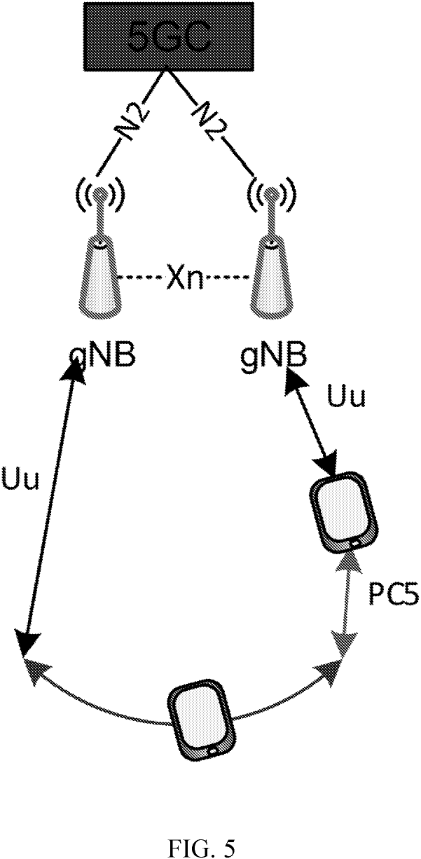

Aspects of the present disclosure involves a remote UE, a relay UE, and a network, as shown in FIG. 5, which is a high level path diagram illustrating example connection paths: a Uu path between the remote UE and the network gNB, a PC5 path between the remote UE and the relay UE, and a Uu path between the relay UE and the network gNB. The remote UE and the relay UE may be in radio resource control (RRC) connected mode when the switch is performed. In general, the present disclosure concerns when and how to imitate the switch of the remote UE between the Uu path and the PC5 path.

In some embodiments, the disclosed methods provide and implement a mobility trigger that onsets the switch. The mobility trigger may utilize downlink (DL) measurements of the remote UE. For example, the remote UE may provide intra-frequency, inter-frequency, and inter-RAT measurements to the network for a determination whether the criteria for a switch are met. In some cases, the network may decide when to initiate the switch based on the DL measurements. In other cases, the remote UE may decide and initiate the switch using the DL measurements.

Upon taking action to initiate the switch, a target link (either a PC5 or Uu connection) maybe established. The target link establishment may include a context transfer before the remote UE switch to the target link. For example, the switch may include the target link establishment as well as configuration of dedicated/common UE resources based on the context of the existing connection of the remote UE. Upon completion, the switch may include forwarding data from the source connection to the target connection. In some cases, U-plane switch may be included. In other cases, release resources at the source cell may also be included.

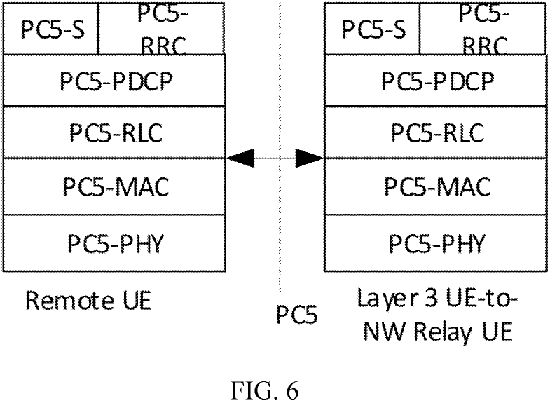

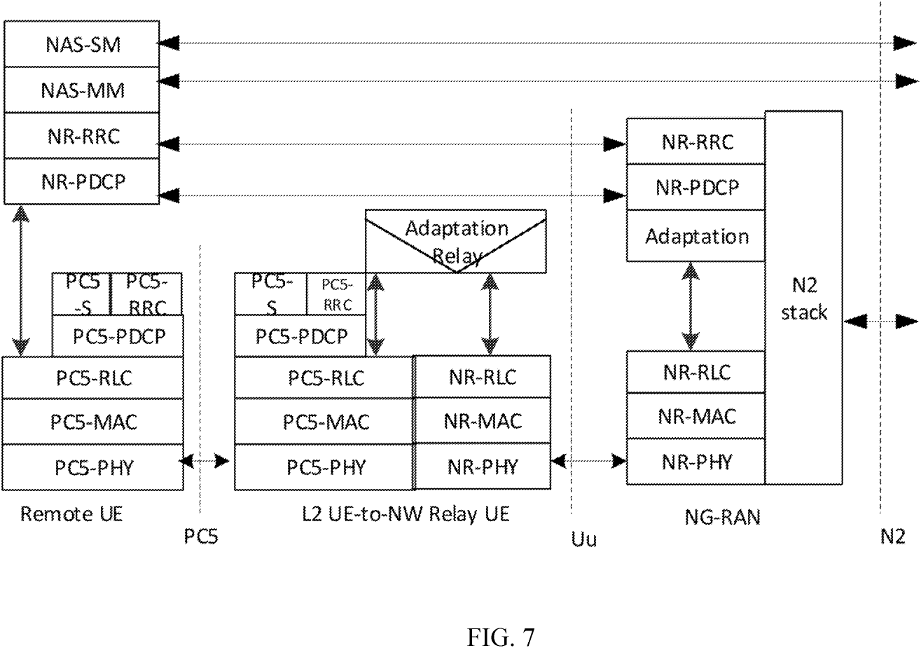

As shown in FIG. 6 and FIG. 7, remote UE may generally connect to a relay UE via a layer 3 (L3) connection with no Uu connection with (and no visibility to) the network or via a layer 2 (L2) connection where the UE supports Uu access stratum (AS) and non-AS connections (NAS) with the network.

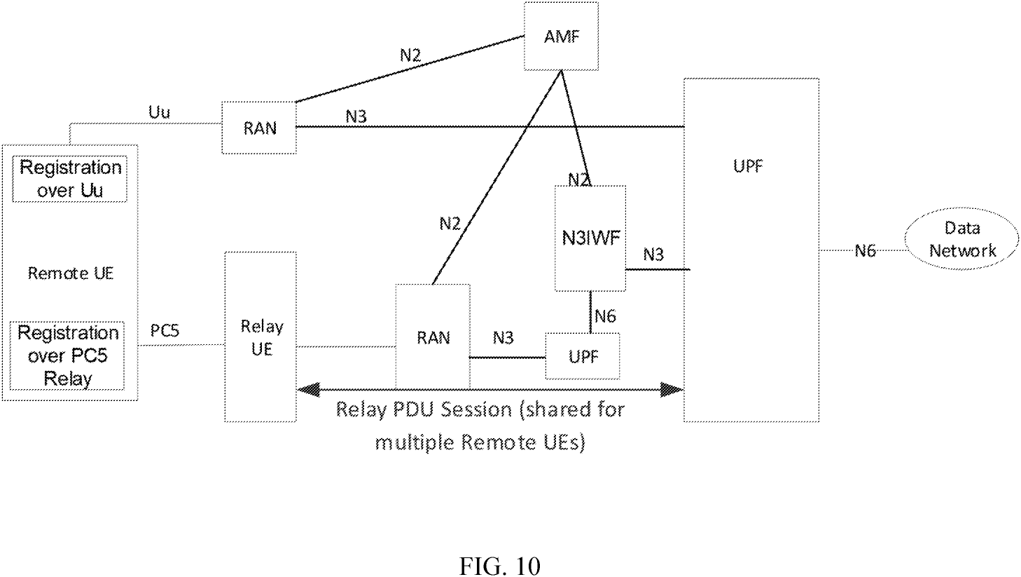

FIG. 6 is an example block diagram illustrating a control plane protocol stack on L3, when there is no direct connection path (Uu connection) between the remote UE and the network node. In this situation, the remote UE does not have a Uu connection with a network and is connected to the relay UE via PC5 connection only (e.g., Layer 3 UE-to-NW). The PC5 unicast link setup may, in some implementations, be needed for the relay UE to serve the remote UE. The remote UE may not have a Uu application server (AS) connection with a radio access network (RAN) over the relay path. In other cases, the remote UE may not have direct none access stratum (NAS) connection with a 5G core network (5GC). The relay UE may report to the 5GC about the remote UE’s presence. Alternatively and optionally, the remote UE may be visible to the 5GC via a non-3GPP interworking function (N3IWF), as shown in FIG. 10.

FIG. 7 is an example block diagram illustrating a control plane protocol stack on L2, when there is direct connection path between the remote UE and the network node. This control plane protocol stack refers to an L2 relay option based on NR-V2X connectivity. Both PC5 control plane (C-plane) and the NR Uu C-plane are on the remote UE, similar to what is illustrated in FIG. 6. The PC5 C-plane may set up the unicast link before relaying. The remote UE may support the NR Uu AS and NAS connections above the PC5 radio link control (RLC). The NG-RAN may control the remote UE’s PC5 link via NR radio resource control (RRC). In some embodiments, an adaptation layer may be needed to support multiplexing multiple UEs traffic on the relay UE’s Uu connections.

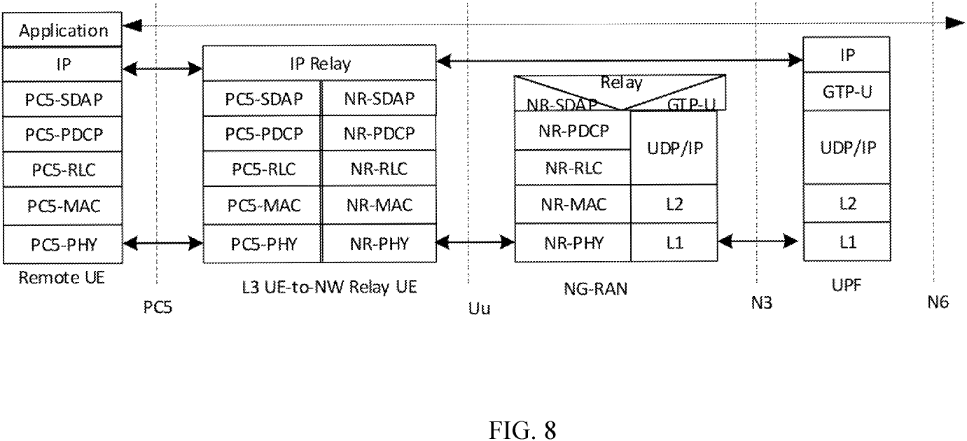

FIG. 8 is an example block diagram illustrating a user plane protocol stack on L3, when there is no direct connection path between the remote UE and the network node. As shown, the L3 relay UE acts as an IP router. The relay UE may forward the remote UE’s traffic to the core network (CN) using the relay UE’s own protocol data unit (PDU) session. In some implementations, local routing between the remote UE and the relay UE, or between a remote UE and another remote UE, is possible. Non-IP traffic may be supported by encapsulation in IP, or dedicated PDU session per remote UE.

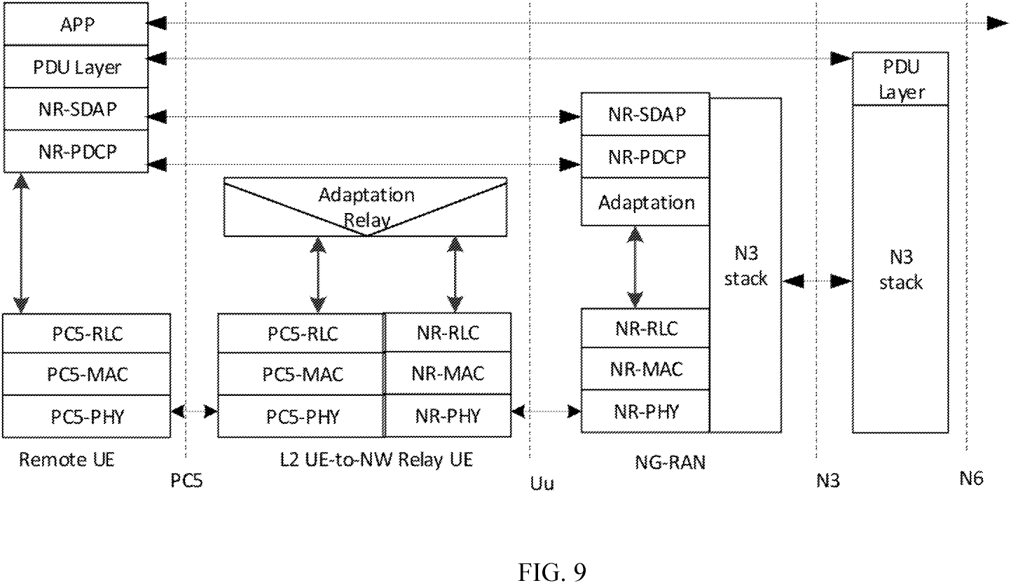

FIG. 9 is an example block diagram illustrating a user plane protocol stack on L2, when there is direct connection path between the remote user equipment and the network node. As shown, in this L2 relay option, the relay UE may perform relay below the packet data convergence protocol (PDCP). The relay UE may forward PC5 bearer and Uu bearer using an adaptation layer function. In some embodiments, the remote UE’s dedicated radio bearers (DRBs) may be controlled by the network (NG-RAN). As shown, traffic may terminate at 5GC, where there are no direct communication between the remote UEs or to the relay UE.

FIG. 10 is an example block diagram illustrating an architecture scheme of L3 relay enhancement with N3IWF. The N3IWF may be an optional way to support service continuity and equipment-to-equipment security for L3 Relay. The remote UE may perform an independent non-access stratum (NAS) procedures and support end-to-end security over the user plane via the UE-to-NW Relay or N3IWF. For example, the remote UE may reach the N3IWF over Relay’s PDU session. The remote UE may discover the N3IWF and send the NAS signaling to the N3IWF IP address. The remote UE may establish a PDU session via N3IWF and obtain an inner IP address for accessing 5G services. As such, mobility with IP preservation support may be achieved by maintaining the PDU session with N3IWF.

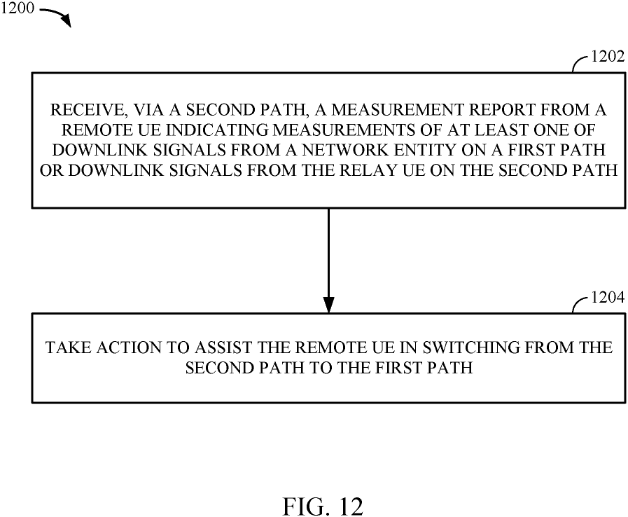

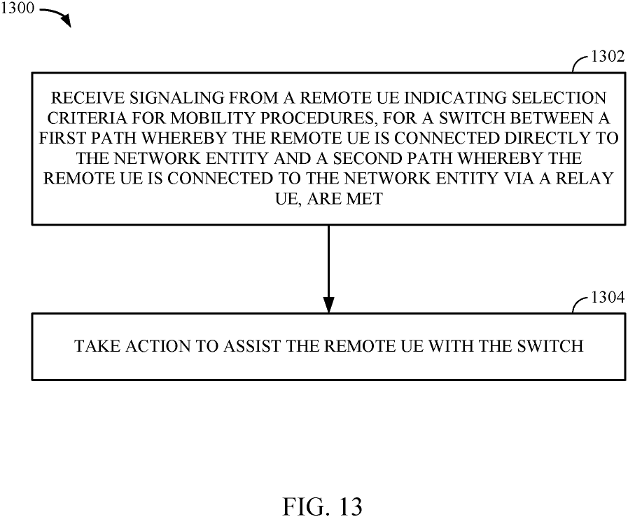

FIG. 11 illustrates example operations 1100 that may be performed by a remote UE to switch network connections between first (Uu) and second (PC5) paths, while FIGS. 12 and 13 illustrate corresponding operations 1200 and 1300 from the relay UE and network perspective, respectively.

Operations 1100 begin, at 1102, by receiving signaling for a configuration of selection criteria for mobility procedures for a switch between a first path and a second path. The remote UE is connected directly to a network entity (e.g., NG-RAN, or gNB) by the first path, such as a Uu path. The remote UE is connected to the network entity via a relay UE by the second path, such as a PC5 path to the relay UE. The switch between the first path and the second path may be either switching from the first path to the second path or switching from the second path to the first path.

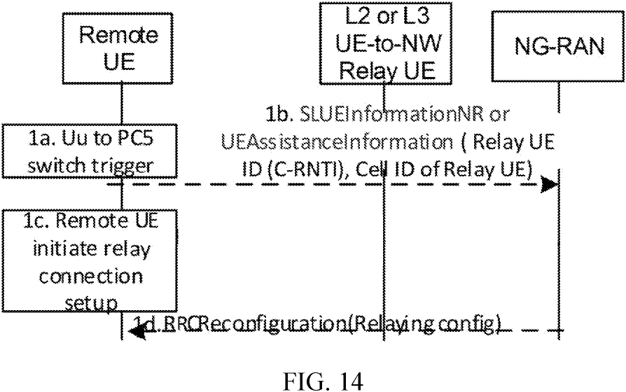

In certain aspects, the received signaling for a configuration may be provided via at least one of: a system information block (SIB) from the network entity or radio resource control (RRC) signaling or NAS signaling from a point coordination function (PCF). For example, as shown in FIG. 14, which illustrates an example call flow diagram showing overall trigger related communication, the remote UE first determines a Uu to PC5 switch trigger and sends the trigger information to NG-RAN. The switch trigger may be in response to relay (re)selection criteria configured at the remote UE, by gNB (in SIB), or PCF in pre-configuration RRC container for out-of-coverage (ORC) operation.

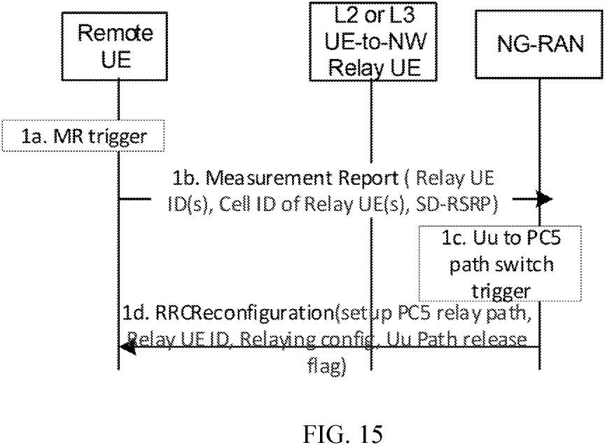

In certain aspects, the remote UE sends downlink measurements performed by the remote UE as part of the configuration of selection criteria to either the relay UE or the network, as illustrated in FIGS. 15-17. In some embodiments, the configuration may indicate the downlink measurements and the selection criteria involves the downlink measurements. Further discussion of FIGS. 15-17 are provided below.

At 1104, the remote UE takes action to initiate the switch if the selection criteria are met. As shown in FIG. 5, the remote UE may connect to the 5GC via a direct Uu connection to a first gNB or via an indirect connection including a PC5 connection to the relay UE and a Uu connection between the relay UE and the second gNB. The term “switch” here is not exclusive, meaning that the remote UE may select one of the two connections as a primary connection while maintaining the other connection. In some examples, however, the switch may include specific instructions in certain scenarios to have the remote UE release one of the non-selected connections, as described below.

In certain aspects, the remote UE may initiate the switch from the Uu path to the PC5 path if certain relay reselection criteria are met, based on measurements of downlink signals from the relay UE. In some embodiments, if the remote UE is still in coverage of the initial Uu connection, initiating the switch from the Uu path to the PC5 path may include sending the network entity assistance information. In such situation, the remote UE controls the switch while assisted by the network. For example, as shown in FIG. 14, after the remote UE initiates the Uu to PC5 switch trigger at 1a, at 1b, the remote UE sends sidelink information (SLUEInformationNR) or UE assistance information to the network (NG-RAN). In some implementations, the assistance information may include at least one of: a cell ID of the serving cell of the relay UE, a cell radio network temporary identifier (C-RNTI) of the relay UE.

As shown in FIG. 14, the remote UE receives an RRC reconfiguration signaling from the network entity. The RRC reconfiguration signaling instructs the remote UE on the configuration to connect to the relay UE.

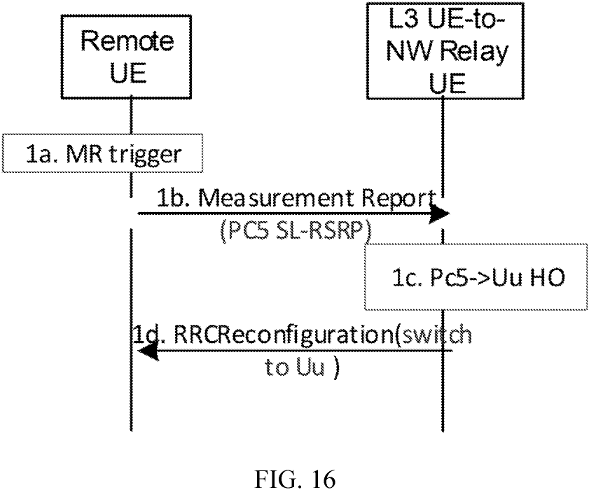

In some other cases, the network may control the switch while the remote UE assists the network. For example, as shown in FIG. 15, the remote UE may report measurements for both the Uu path and the PC5 path to the network. The network may configure the relay specific PC5 measurement criteria and determine when the switch may be triggered. In situations where the remote UE is out of coverage, the relay specific PC5 measurements criteria may be configured by PCF in the pre-configuration RRC container. When the remote UE reports measurements of the Uu connection and the PC5 connection, the remote UE may report measurements to the relay UE for L3 relay or to gNB for L2 relay. For example, as shown in FIG. 16, the remote UE reports the measurements to the relay UE if the remote UE does not maintain a connection to both the network entity and the relay UE (i.e., L3 relay between the remote UE and the relay UE). The relay UE based on the measurement results from UE may decide to switch the connection from the PC5 path to the Uu path and may thereafter send an RRC reconfiguration message to the remote UE to switch the connection from the PC5 path to the Uu path.

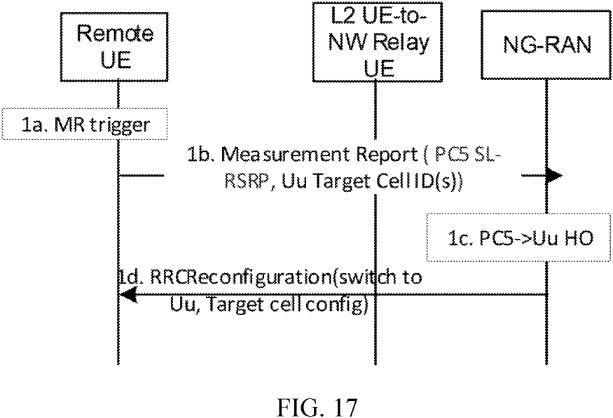

An example of L2 relay is illustrated in FIG. 17. The remote UE may report the measurements directly to the network entity if the remote UE maintains a connection to both the network entity and the relay UE. In L2 relay, the remote UE may report the measurements via the relay UE to the network entity. The network entity (e.g., NG-RAN) may send a handover (HO) command to the remote UE, instructing a switch from the PC5 path to the Uu path. The Remote UE connected via L3 relay that is in-coverage of gNB may also use this option to send mobility request over the Uu connection to the network entity directly.

Returning to FIG. 15, in some embodiments, the remote UE may initiate the switch from the Uu path to the PC5 path if relay reselection criteria are met, based on measurements of downlink signals from the relay UE. The initiation of the switch from the Uu path to the PC5 path may include sending the network entity a measurement report indicating one or more relays and corresponding measurements. For example, the remote UE may receive RRC reconfiguration signaling (e.g., step 1d) from the network entity instructing the UE to connect to one of the relays indicated in the measurement report (e.g., step 1b).

In other specific aspects, the remote UE in-coverage of gNB may report the sidelink measurements to the network entity (gNB) when Uu path is available. As such, this is suitable for both L3 and L2 relays. As shown in FIG. 15, the measurement report may include one or more of the following for each relay UE discovered: the relay UE’s ID (C-RNTI or L2 ID)); the SL link quality (SD-RSRP); and the Cell ID of serving cell of Relay UE. The network entity may trigger the switch (or handover) and send the selected relay information to the remote UE.

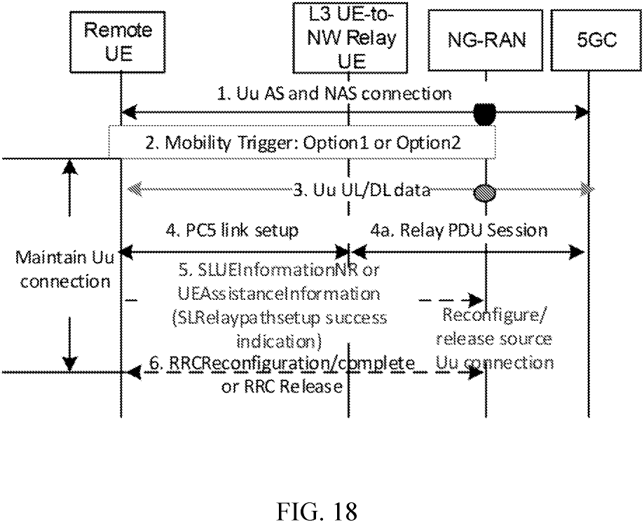

In another aspect, as in the example implementation shown in FIG. 18, if the RRC signaling also indicates the remote UE is to release resources associated with the first path, the remote UE releases the resources associated with the first path (e.g., step 6). FIG. 18 is an example call flow diagram showing a Uu-PC5 mobility switch. In general, assumptions under the LTE ProSe path switch may be applicable as a base line. The Uu connection may be maintained while setting up the PC5 relay connection, such as to support service session continuity, in the absence of IP session continuity. The Uu connection maintenance may be optional and controlled by NG-RAN via a Uu path release indication upon the mobility trigger at step 2. If the IE is not set, then source connection is maintained and below behavior applies. At step 5, the UE assistance information can be used to indicate to the NG-RAN that PC5 relay path setup is successful. The NG-RAN may reconfigure the Uu connection or suspend/release the Uu connection.

At step 6 of FIG. 18, the NG-RAN may use RRC reconfiguration message or RRC release message to complete the switch. For example, if the RRC signaling does not indicate the remote UE is to release resources associated with the Uu path, the remote UE may maintain the Uu path and provide an indication to the network entity, via the Uu path, the UE successfully connected to a relay UE. The example call flow may also be suitable for L3 relay with or without N3IWF architecture options mentioned in FIG. 10.

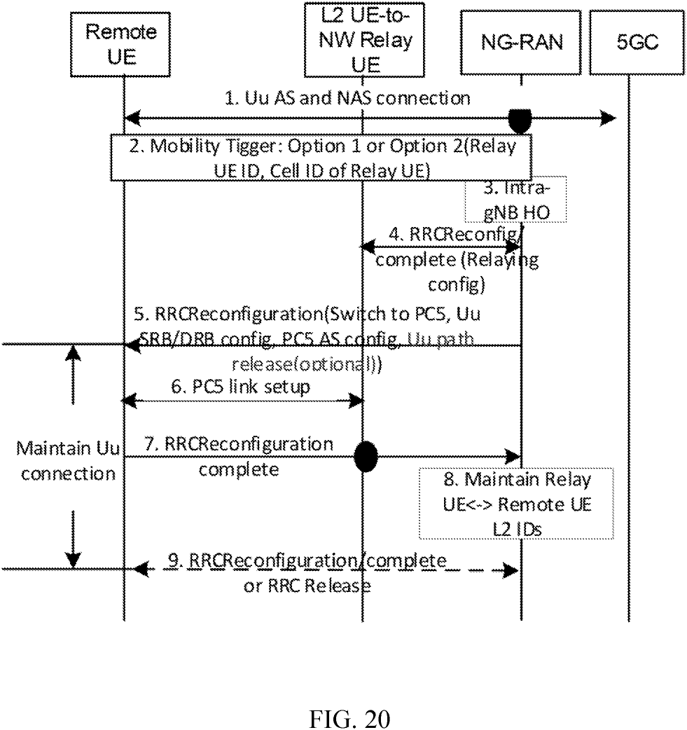

In certain aspects, if the RRC signaling indicates the remote UE is to release resources associated with the first path, the remote UE may release the resources associated with the first path before connecting with the relay UE via the second path. For example, as shown in FIG. 20, an example call flow diagram shows a Uu-PC5 switch, the remote UE informs the NG-RAN on the relay UE ID and Cell ID of Relay UE in step 2. The NG-RAN configures the relay UE for relaying (via step 4), by sending one or more of: PC5 AS (RLC/MAC/PHY) configuration, Uu AS configuration (RLC/MAC/PHY), and adaptation layer configuration. In some embodiments, the Uu connection is maintained until the PC5 relay path setup indicated via a “Uu path release” field in step 5. When the Uu path release field is present, the UE may release the Uu path before the PC5 path is completely setup (step 5). When the Uu path release field is not present, the network and the remote UE may use the Uu path similar to a dual active protocol stack (DAPS) handover but with simultaneous uplink and downlink supported.

In certain aspects, the remote UE may initiate the switch from the Uu path to the PC5 path if relay reselection criteria are met based on measurements of at least one of downlink signals from the relay UE or downlink signals from the network entity. The remote UE may initiate the switch from the Uu path to the PC5 path by sending, to at least one of the network entity or the relay UE, a measurement report indicating at least one of: (1) one or more relays and corresponding measurements, or (2) one or more target cell IDs and corresponding measurements. For example, as shown in both FIGS. 16 and 17, the remote UE has options to set the destination of the measurements of downlink signals. As shown in FIG. 16, if the remote UE does not have a connection with the network entity via the Uu path, the measurement report may be sent to the relay UE and the relay UE may decide whether or not to handover the remote UE from the PC5 path to the Uu path. In FIG. 7, by comparison, the remote UE may directly send the measurement report to the network entity via the Uu path.

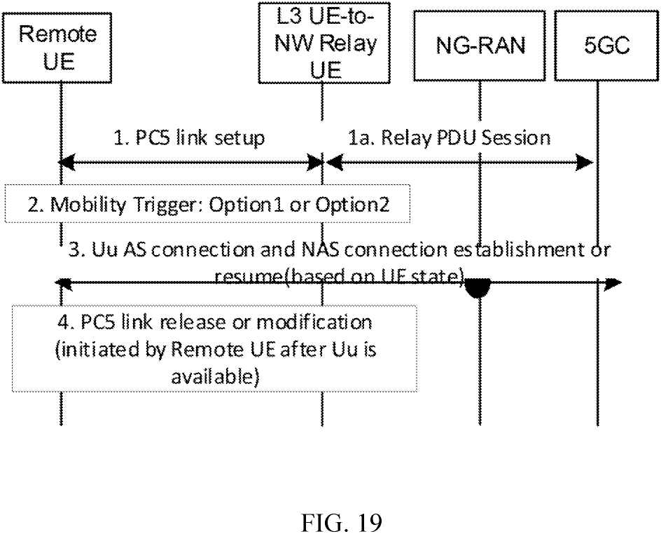

In some specific aspects, as illustrated in FIG. 19, the remote UE may further provide an indication to the relay UE that the remote UE has successfully connected to the network entity via the Uu path. For example, at step 4, the remote UE may send the relay UE a PC5 link release or modification after the Uu path has become available after the switch. FIG. 19 is an example call flow diagram showing a Uu-PC5 mobility switch returning to a Uu path connection. The Uu connection may be maintained while the PC5 relay connection is ongoing. The remote UE may maintain the PC5 relay path until the Uu connection has become active. At step 4, the remote UE may indicate the Uu path setup is successful to the Relay UE, as the release or modification cause.

In another specific aspect, if the remote UE has a connection with the network entity via the Uu path, the measurement report may be sent to the network entity. As shown in FIG. 17, the network entity may decide whether or not to handover the remote UE from the PC5 path to the Uu path at step 1c. The UE may receive a RRC reconfiguration signaling from the network entity instructing the remote UE to switch to the Uu path at step 1d.

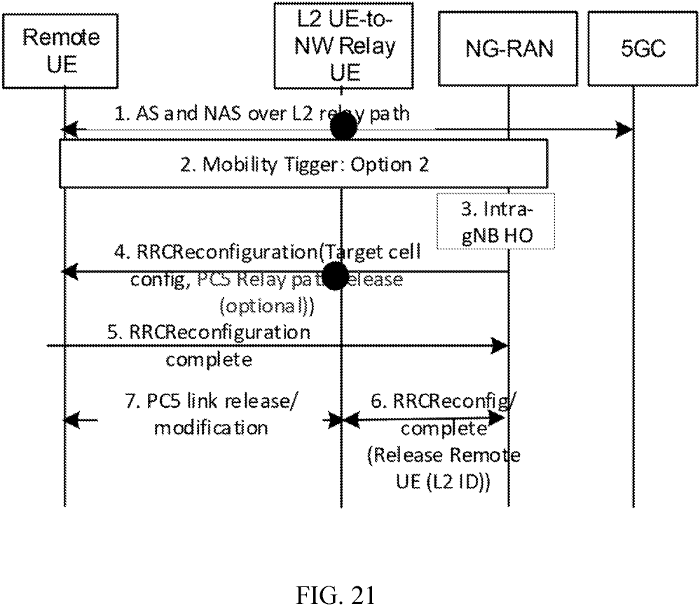

For example, as illustrated in FIG. 21, if the RRC signaling also indicates the remote UE is to release resources associated with the PC5 path at step 4, the remote UE may release resources associated with the PC5 path before sending an RRC reconfiguration complete message via the Uu path at step 6. Furthermore, if the RRC signaling does not indicate the remote UE is to release resources associated with the PC5 path, the remote UE may maintain the PC5 path while reconfiguring bearers for the Uu path. The remote UE may reconfigure bearers to Uu path and maintains PC5 relay path in similar manner as a DAPS handover. In some embodiments, the target cell configuration may be the same as the configuration indicated in the Uu handover when necessary. Steps 6 and 7 may be initiated by the network entity after a successful switch from PC5 path to Uu path, thus having the relay UE to release the PC5 path.

As noted above, FIG. 12 is a flow diagram 1200 illustrating example operations that may be performed by the relay UE to assist the switch of the remote UE as discussed above. At 1202, the relay UE may receive, via the PC5 path, a measurement report from the remote UE indicating measurements of at least one of downlink signals from a network entity on the Uu path or downlink signals form the relay UE on the PC5 path. At 1204, the relay UE may take action(s) to assist the remote UE in switching from the PC5 path to the Uu path. For example, as disclosed herein, FIGS. 16, 21, 22, and 23 illustrate the operations by the relay UE in assisting the switch of connection paths of the remote UE in various implementations. As discussed in relation to FIG. 16 above, the relay UE may take actions to determine, based on the measurement report, if selection criteria for mobility procedures for a switch of the UE between the first path and the second path are met. The relay UE may take action(s) to initiate handover of the remote UE from the second path to the first path if the section criteria are met, such as, for example, sending the remote UE an RRC reconfiguration message indicating the remote UE is to switch to the Uu path.

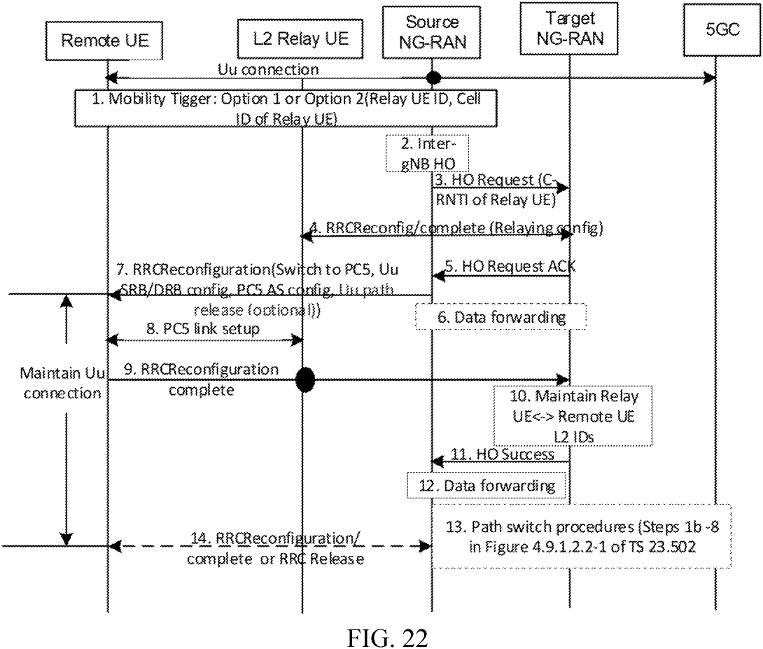

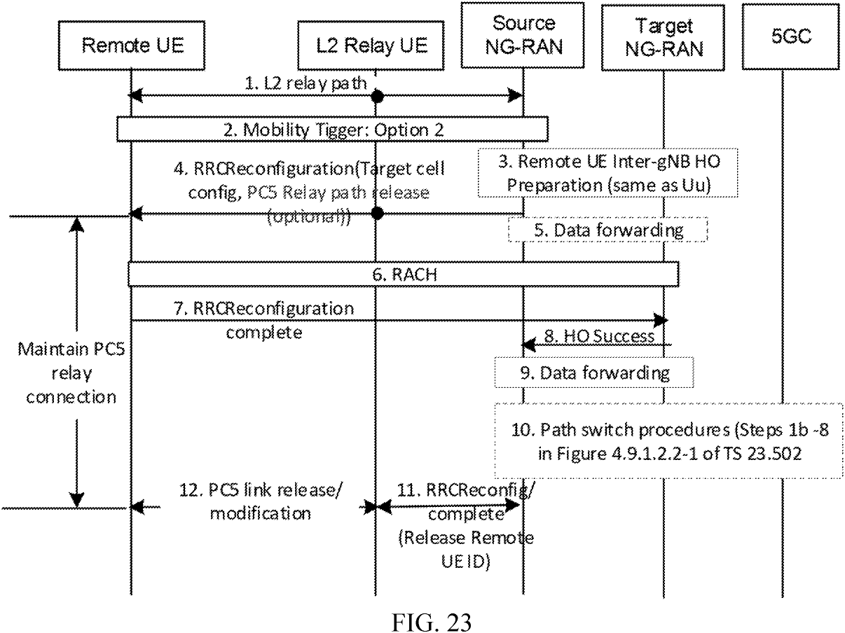

In some embodiments, as mentioned in relation to FIG. 21 above, the relay UE may receive from the remote UE an indication that the remote UE has successfully connected to the network entity via the Uu path. Another embodiment may include the relay UE forwarding the measurement report to the network entity to enable the network entity to decide whether to handover the remote UE from the PC 5 path to the Uu path, as shown in FIG. 23. Other specific embodiments illustrated in FIGS. 22 and 23 are further discussed below.

As noted above, FIG. 13 is a flow diagram 1300 illustrating example operations that may be performed by a network entity to assist the switch of the remote UE as discussed above. At 1302, the network entity may receive signaling from the remote UE indicating selection criteria for mobility procedures, for a switch between a Uu path and a PC5 path, are met. At 1304, the network entity may take action(s) to assist the remote UE with the switch. For example, as disclosed herein, FIGS. 14, 15, 17, 19, 20, and 22 illustrate the operations by the network entity in assisting the switch of connection paths of the remote UE in various implementations.

FIG. 22 is an example call flow diagram showing a Uu-PC5 mobility switch in an inter-network setting, in accordance with the procedures discussed above. As shown, an Xn based handover (HO) procedure is shown. The disclosed HO procedure may differ from conventional HO procedures. For example, the source S-NG-RAN may pass the C-RNTI of the relay UE via S-AMF/T-AMF to the target T-NG-RAN (HO Required/ HO request messages). The target T-NG-RAN may configure the relay UE before sending HO Request ACK to T-AMF. Data forwarding may start early (i.e., at step 5) or later (i.e., at step 9), based on whether the PC5 relay path is maintained until Inter-gNB HO is successful (similar to DAPS HO).

FIG. 23 is another example call flow diagram showing a Uu-PC5 mobility switch in an inter-network setting, in accordance with the procedures discussed above. Specifically, the inter-gNB HO procedures may be the same as the Uu HO procedures for both Xn and N2 based situations. Unlike existing procedures, however, step 4 provides an optional PC5 relay path release from the relay UE to the remote UE. As such, early data forwarding at step 5 is supported. In some embodiments, the support of early data forwarding may depend on whether the PC5 relay path is maintained until Inter-gNB HO is successful (similar to DAPS HO).

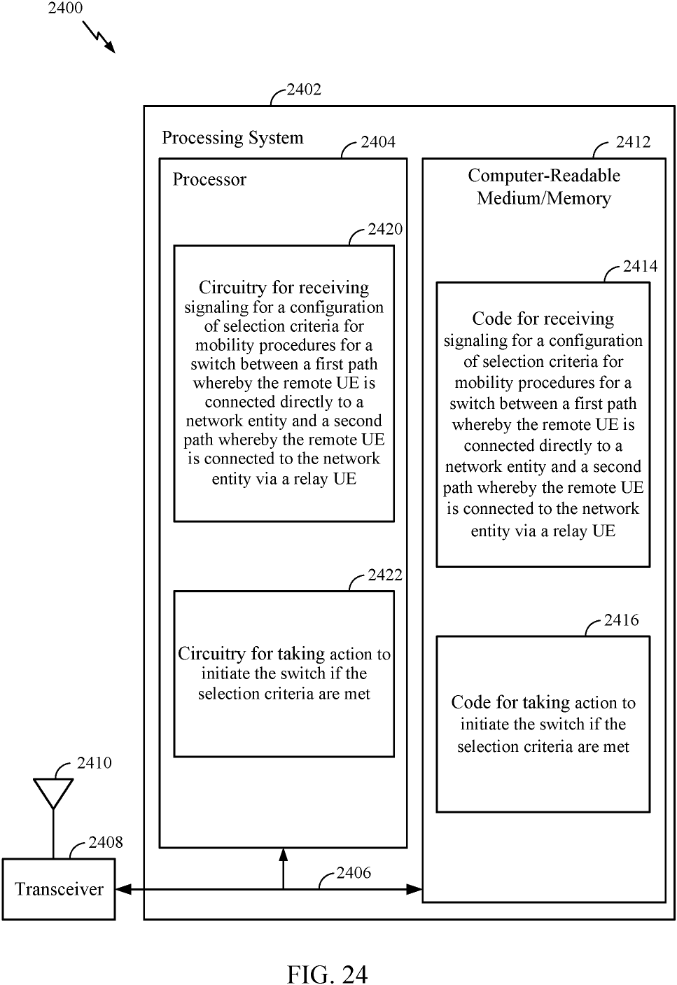

FIG. 24 illustrates a communications device 2400 that may include various components (e.g., corresponding to means-plus-function components) configured to perform operations for the techniques disclosed herein, such as the operations illustrated in FIG. 11. The communications device 2400 includes a processing system 2402 coupled to a transceiver 2408. The transceiver 2408 is configured to transmit and receive signals for the communications device 2400 via an antenna 2410, such as the various signals as described herein. The processing system 2402 may be configured to perform processing functions for the communications device 2400, including processing signals received and/or to be transmitted by the communications device 2400.

The processing system 2402 includes a processor 2404 coupled to a computer-readable medium/memory 2412 via a bus 2406. In certain aspects, the computer-readable medium/memory 2412 is configured to store instructions (e.g., computer-executable code) that when executed by the processor 2404, cause the processor 2404 to perform the operations illustrated in FIG. 11, or other operations for switching between a PC5 path and a Uu path. In certain aspects, computer-readable medium/memory 2412 stores code 2414 for receiving signaling for a configuration of selection criteria for mobility procedures for a switch between a first path whereby the remote UE is connected directly to a network entity and a second path whereby the remote UE is connected to the network entity via a relay UE; and code 2416 for taking action(s) to initiate the switch if the selection criteria are met. In certain aspects, the processor 2404 has circuitry configured to implement the code stored in the computer-readable medium/memory 2412. The processor 2404 includes circuitry 2420 for receiving signaling for a configuration of selection criteria for mobility procedures for a switch between a first path whereby the remote UE is connected directly to a network entity and a second path whereby the remote UE is connected to the network entity via a relay UE; and circuitry 2414 for taking action(s) to initiate the switch if the selection criteria are met.

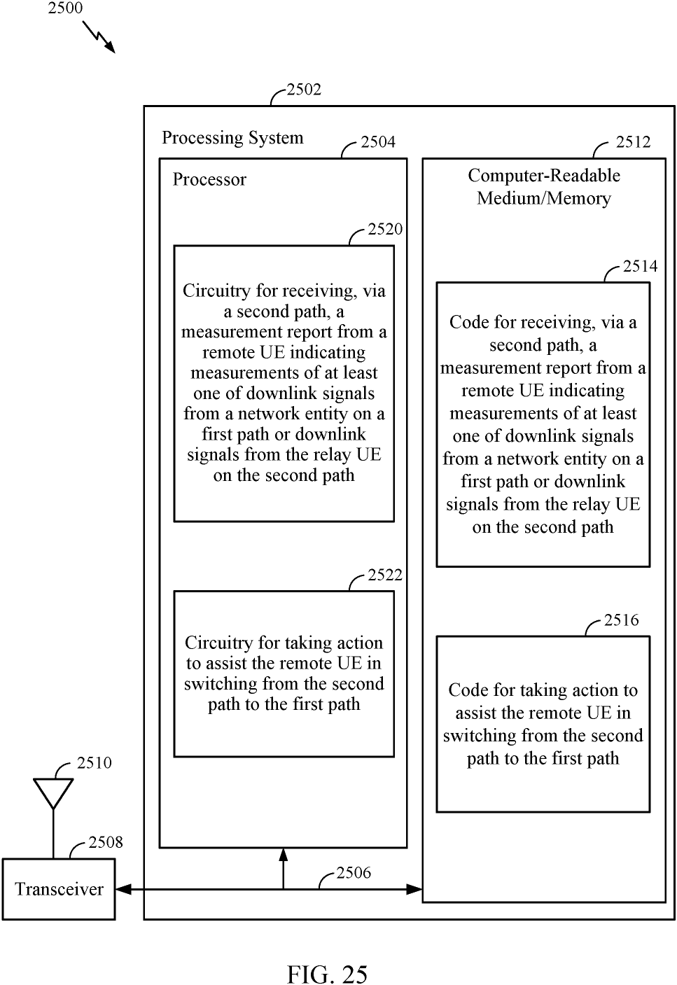

FIG. 25 illustrates a communications device 2500 that may include various components (e.g., corresponding to means-plus-function components) configured to perform operations for the techniques disclosed herein, such as the operations illustrated in FIG. 12. The communications device 2500 includes a processing system 2502 coupled to a transceiver 2508. The transceiver 2508 is configured to transmit and receive signals for the communications device 2500 via an antenna 2510, such as the various signals as described herein. The processing system 2502 may be configured to perform processing functions for the communications device 2500, including processing signals received and/or to be transmitted by the communications device 2500.

The processing system 2502 includes a processor 2504 coupled to a computer-readable medium/memory 2525 via a bus 2506. I n certain aspects, the computer-readable medium/memory 2512 is configured to store instructions (e.g., computer-executable code) that when executed by the processor 2504, cause the processor 2504 to perform the operations illustrated in FIG. 12 or other operations for assisting the remote UE in switching paths. In certain aspects, computer-readable medium/memory 2512 stores code 2514 for receiving, via a second path, a measurement report from a remote UE indicating measurements of at least one of downlink signals from a network entity on a first path or downlink signals from the relay UE on the second path; and code 2516 for taking action(s) to assist the remote UE in switching from the second path to the first path. In certain aspects, the processor 2504 has circuitry configured to implement the code stored in the computer-readable medium/memory 2512. The processor 2504 includes circuitry 2520 for receiving, via a second path, a measurement report from a remote UE indicating measurements of at least one of downlink signals from a network entity on a first path or downlink signals from the relay UE on the second path; and circuitry 2522 for taking action(s) to assist the remote UE in switching from the second path to the first path. In certain aspects.

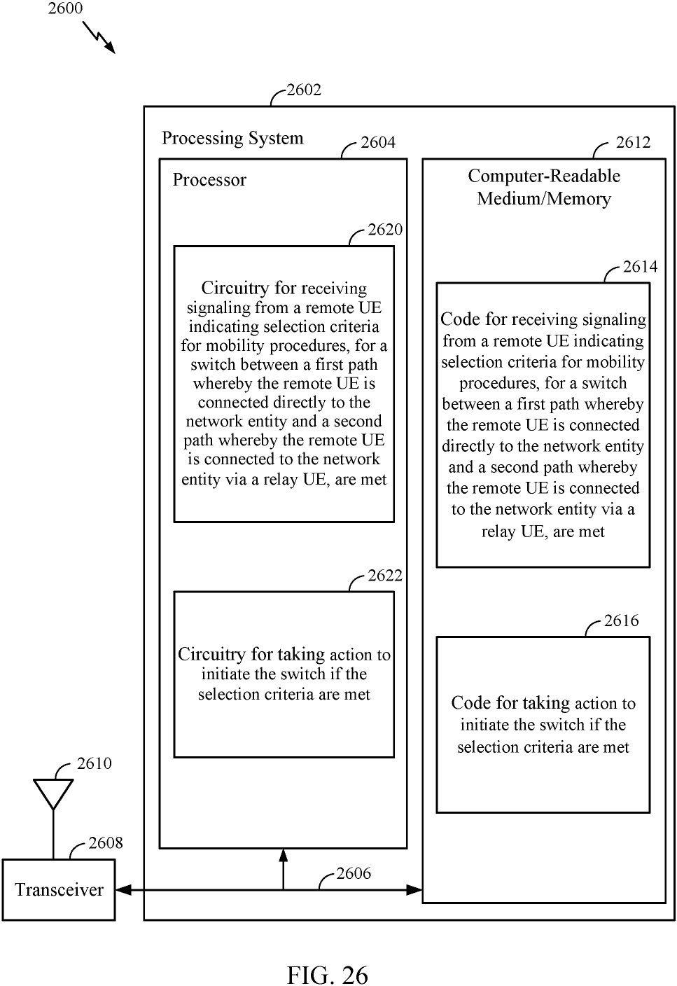

FIG. 26 illustrates a communications device 2600 that may include various components (e.g., corresponding to means-plus-function components) configured to perform operations for the techniques disclosed herein, such as the operations illustrated in FIG. 13. The communications device 2600 includes a processing system 2602 coupled to a transceiver 2608. The transceiver 2608 is configured to transmit and receive signals for the communications device 2600 via an antenna 2610, such as the various signals as described herein. The processing system 2602 may be configured to perform processing functions for the communications device 2600, including processing signals received and/or to be transmitted by the communications device 2600.

The processing system 2602 includes a processor 2604 coupled to a computer-readable medium/memory 2626 via a bus 2606. I n certain aspects, the computer-readable medium/memory 2612 is configured to store instructions (e.g., computer-executable code) that when executed by the processor 2604, cause the processor 2604 to perform the operations illustrated in FIG. 13 or other operations for assisting the remote UE with the switch between paths. In certain aspects, computer-readable medium/memory 2612 stores code 2614 for receiving signaling from a remote UE indicating selection criteria for mobility procedures, for a switch between a first path whereby the remote UE is connected directly to the network entity and a second path whereby the remote UE is connected to the network entity via a relay UE, are met; and code 2616 for taking action to initiate the switch if the selection criteria are met. In certain aspects, the processor 2604 has circuitry configured to implement the code stored in the computer-readable medium/memory 2612. The processor 2604 includes circuitry 2620 for receiving signaling from a remote UE indicating selection criteria for mobility procedures, for a switch between a first path whereby the remote UE is connected directly to the network entity and a second path whereby the remote UE is connected to the network entity via a relay UE, are met; and circuitry 2622 for taking action to initiate the switch if the selection criteria are met.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 11, 12, and 13 may be performed by various processors shown in FIG. 4, such as processors 466, 458, 464, and/or controller/processor 480 of the UE 120a.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 11, 12, and 13.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1-48. (canceled)

49. A method for wireless communication by a remote user equipment (UE), comprising:
receiving signaling for a configuration of selection criteria for mobility procedures for a switch between a first path whereby the remote UE is connected directly to a network entity and a second path whereby the remote UE is connected to the network entity via a relay UE; and
taking action to initiate the switch if the selection criteria are met.

50. The method of claim 49, wherein the configuration indicates downlink measurements to be performed by the remote UE and is signaled via at least one of: a system information block (SIB) from the network entity or radio resource control (RRC) signaling, and wherein the selection criteria involve the downlink measurements.

51. The method of claim 49, wherein:
the network entity in the second path is different than the network entity of the first path.

52. The method of claim 49, wherein:
the remote UE initiates the switch from the first path to the second path if relay selection criteria are met, based on measurements of downlink signals from the relay UE; and
initiating the switch from the first path to the second path comprises sending the network entity assistance information.

53. The method of claim 52, wherein the assistance information comprises at least one of: a cell ID of the serving cell of the relay UE, a cell radio network temporary identifier (C-RNTI) of the relay UE, or a PC5 source layer 2 identifier (L2 ID) of the relay UE.

54. The method of claim 52, further comprising receiving radio resource control (RRC) reconfiguration signaling from the network entity instructing the UE to connect to the relay UE.

55. The method of claim 49, wherein:
the remote UE reports measurements for both the first path and the second path, wherein the remote UE reports the measurements directly to the network entity if the remote UE maintains a connection to both the network entity and relay UE.

56. The method of claim 49, further comprising setting or modifying a PC5 unicast connection with the relay UE for relaying, in response to receiving a radio resource control (RRC) reconfiguration signaling from the network entity.

57. The method of claim 55, wherein the remote UE reports the measurements to the network via the relay UE if the remote UE does not maintain a connection to both the network entity and relay UE.

58. The method of claim 49, wherein:
the remote UE initiates the switch from the first path to the second path if relay selection criteria are met, based on measurements of downlink signals from the relay UE; and
initiating the switch from the first path to the second path comprises sending the network entity a measurement report indicating one or more relays and corresponding measurements.

59. The method of claim 58, further comprising receiving radio resource control (RRC) reconfiguration signaling from the network entity instructing the UE to connect to one of the relays indicated in the measurement report.

60. The method of claim 59, wherein, if the RRC signaling also indicates the remote UE is to release connections associated with the first path, the remote UE releases connections associated with the first path.

61. The method of claim 60, wherein, if the RRC signaling indicates the remote UE is to release connections associated with the first path, the remote UE releases the connections associated with the first path before connecting with the relay UE via the second path.

62. The method of claim 49, wherein:
the remote UE initiates the switch from the second path to the first path if relay reselection criteria are met, based on measurements of at least one of downlink signals from the relay UE or downlink signals from the network entity; and
initiating the switch from the second path to the first path comprises sending, to at least one of the network entity or relay UE, a measurement report indicating at least one of: second path link quality and the measurements of one or more target cells for first path.

63. The method of claim 62, wherein, if the remote UE does have a connection with the network entity via the first path, the measurement report is sent to the network entity and the network entity decides whether to handover the remote UE from the second path to the first path.

64. The method of claim 63, further comprising receiving radio resource control (RRC) reconfiguration signaling from the network entity instructing the UE to switch to the first path, wherein, if the RRC signaling also indicates the remote UE is to release connections associated with the second path, the remote UE releases resources associated with the second path before sending an RRC reconfiguration complete message via the first path, and wherein, if the RRC signaling does not indicate the remote UE is to release connections associated with the second path, the remote UE maintains the second path while reconfiguring bearers for the first path.

65. A method for wireless communication by a network entity, comprising:
receiving signaling from a remote UE indicating selection criteria for mobility procedures, for a switch between a first path whereby the remote UE is connected directly to the network entity and a second path whereby the remote UE is connected to the network entity via a relay UE, are met; and
taking action to assist the remote UE with the switch.

66. The method of claim 65, wherein:
the remote UE sends the signaling to initiates the switch from the first path to the second path if relay selection criteria are met, based on measurements of downlink signals from the relay UE; and
the signaling comprises assistance information.

67. The method of claim 66, wherein the assistance information comprises at least one of: a cell ID of the serving cell of the relay UE, a cell radio network temporary identifier (C-RNTI) of the relay UE, or a PC5 source layer 2 identifier (L2 ID) of the relay UE.

68. The method of claim 66, further comprising
sending a radio resource control (RRC) reconfiguration signaling indicating relaying configuration to the relay UE, prior to sending the RRC reconfiguration signaling to the remote UE instructing the remote UE to connect to the relay UE.

69. The method of claim 65, wherein:
the signaling comprises a measurement report for both the first path and the second path, wherein the network entity receives the measurement report directly from the remote UE if the remote UE maintains a connection to both the network entity and relay UE, and wherein the network entity receives the measurement report via the relay UE if the remote UE does not maintain a connection to both the network entity and relay UE.

70. The method of claim 65, wherein:
the remote UE sends the signaling to initiate the switch from the first path to the second path if relay selection criteria are met, based on measurements of downlink signals from the relay UE; and
the signaling comprises a measurement report indicating one or more relays and corresponding measurements.

71. The method of claim 69, further comprising sending a radio resource control (RRC) reconfiguration signaling indicating relaying configuration to the relay UE, prior to sending the RRC reconfiguration signaling to the remote UE instructing to connect to one of the one or more relays indicated in the measurement report.

72. The method of claim 70, wherein, if the RRC signaling also indicates the remote UE is to release connections associated with the first path, the remote UE releases connections associated with the first path.

73. The method of claim 65, wherein:
the remote UE sends the signaling to initiate the switch from the second path to the first path if relay reselection criteria are met, based on measurements of at least one of downlink signals from the relay UE or downlink signals from the network entity; and
the signaling comprises a measurement report indicating at least one of: second path link quality and the measurements of one or more target cells for first path.

74. The method of claim 73, wherein taking action comprises deciding, based on the measurement report, to handover the remote UE from the second path to the first path.

75. The method of claim 74, further comprising sending to the remote UE radio resource control (RRC) reconfiguration signaling instructing the remote UE to switch to the first path, wherein, the RRC signaling also indicates the remote UE is to release connections associated with the second path before sending an RRC reconfiguration complete message via the first path.

76. The method of claim 65, further comprising sending, to a target network entity, an indication indicating a configuration of the remote UE, a cell radio network temporary identifier (C-RNTI) of the relay UE and the remote UE, and a PC5 source layer 2 identifier (L2 ID) of the relay UE and the remote UE.

77. An apparatus for wireless communication by a remote user equipment (UE), comprising:
a receiver configured to receive signaling for a configuration of selection criteria for mobility procedures for a switch between a first path whereby the remote UE is connected directly to a network entity and a second path whereby the remote UE is connected to the network entity via a relay UE; and
at least one processor configured to take action to initiate the switch if the selection criteria are met.

78. An apparatus for wireless communication by a network entity, comprising:
a receiver configured to receive signaling from a remote UE indicating selection criteria for mobility procedures, for a switch between a first path whereby the remote UE is connected directly to the network entity and a second path whereby the remote UE is connected to the network entity via a relay UE, are met; and
at least one processor configured to take action to assist the remote UE with the switch.
